(19) United States
(12) Patent Application Publication
(10) Pub. No.: US 2009/0175435 A1
(43) Pub. Date: Jul. 9, 2009

(54) METHOD AND APPARATUS FOR DETERMINING INTERNAL USER FOR CALL CENTER SYSTEM

(75) Inventors: Zhou Yu, Shenzhen (CN); Keping Chen, Shenzhen (CN); Yuanhua Luan, Shenzhen (CN); Kaihuai Ying, Shenzhen (CN)

Correspondence Address: DARBY & DARBY P.C., P.O. BOX 770, Church Street Station, New York, NY, 10008-0770, US

(73) Assignee: Huawei Technologies Co., Ltd., Shenzhen (CN)

(21) Appl. No.: 12/404,987

(22) Filed: Mar. 16, 2009

Related U.S. Application Data
(63) Continuation of application No. PCT/CN2007/070723, filed on Sep. 18, 2007.

(30) Foreign Application Priority Data
Sep. 18, 2006 (CN) 200610152208.0
Sep. 25, 2006 (CN) 200610152676.8

(51) Int. Cl. H04M 3/00

(52) U.S. Cl. 379/243

(57) ABSTRACT

The disclosure relates to a method and apparatus for determining an internal user for a call center system. The information servicing function provided in the existing communication networks may be utilized in the invention. After a call initiated from an internal user for a call center system to an external user fails, the call center system sends the call information to the external user in a timely manner so that the external user can obtain identification information of the internal user for the call center system in a timely and accurate manner. With the invention, the possibility of reaching the internal user for the call center system is enhanced and thus the interests of the external user and the enterprise entity can be secured.

### FIELD OF THE INVENTION

The invention relates to the field of communication technologies, and more particularly, to a method and an apparatus for determining an internal user for a call center system.

### BACKGROUND

At present, in consideration of management and costs, most enterprise entities use call center systems to manage and control call initiation and reception for internal users. A call center system may provide unified access information for an enterprise entity to external users, and also may allow the enterprise entity to provide various kinds of rich customization information over the call center system.

The configuration of a call center system is shown in FIG. 1. Specifically, an internal user for the call center system initiates a call request to an external user and inputs the identification information of the external user to the call center system. After the call center system determines that the identification information is associated with an external user for the call center system through information analysis, a connection is made with the external user via Public Switched Telephone Network (PSTN), Global System for Mobile communications (GSM), Code Division Multiple Access (CDMA) based communication networks or other communication networks, and the call procedure is completed.

When an external user initiates a call to an internal user for the call center system, the external user has to establish a communication connection with the call center system first. After the communication connection is established, the call center system generally will provide information service and play audio prompt, for example, “Welcome to xxx company, please input the identification information of the internal user. Please press x for assistance.” At this time, if the identification information of the internal user for the call center system is known to the external user, the external user may input the identification information of the internal user directly, and the call center system diverts the call to the corresponding internal user. If the identification information of the internal user for the call center system is unknown to the external user, the external user may choose to press a key for assistance. The identification information query service is provided by a special person. The call is diverted by the call center system to the internal user, and the call procedure is completed.

If there is no response from the external user or it is not convenient for the external user to respond while the internal user for the call center system initiates a call to the external user, the communication connection fails this time. At this time, information displayed on the communication terminal of the external user is the identification information of the call center system. After the external user determines the call information, he/she will initiate another call based on the information displayed on the communication terminal of the external user. Typically, this call initiated from the external user is referred to as callback.

In a callback, the call center system is called by the external user. After a connection is established, the call center system will provide information service to the external user, for example, “please input the identification information of the internal user”, or query for the identification information, turn to manual service, depending on the configuration of the call center system by the enterprise entity. But the external user is generally not aware of the identification information of the internal user that called himself/herself for the call center system, and thus the call fails.

Presently, there is no effective solution to the problem that the identification information of the internal user for the call center system cannot be determined when the external user makes a callback.

### SUMMARY

An object of the invention is to provide a method for determining an internal user for a call center system so that the call center system may send the identification information of the internal user to the external user in a timely and accurate manner and thus the possibility of reaching the internal user for the call center system may be enhanced.

The object of the invention is achieved with the following solutions.

A method for determining an internal user for a call center system, includes:

determining call information by the call center system after a call initiated from the internal user for the call center system to an external user for the call center system via the call center system fails, the call information including identification information of the internal user for the call center system initiating the call; and

transmitting, by the call center system, the call information to the external user for the call center system.

An intelligent communication apparatus, includes:

a call information determining unit, configured to determine call information after a call initiated from an internal user for a call center system to an external user for the call center system via the call center system fails, the call information including identification information of the internal user for the call center system initiating the call; and

an information transmitting unit, configured to transmit the call information to the external user.

A method for determining an internal user for a call center system, includes:

establishing, by a call center system, information about a correspondence relationship between the internal user for the call center system and an external user for the call center system, after a call initiated from the internal user for the call center system to the external user for the call center system via the call center system fails; and

determining, by the call center system, information about the internal user for the call center system corresponding to the external user for the call center system based on the information about the correspondence relationship after the external user for the call center system initiates a call.

An intelligent communication apparatus, includes:

a storing unit, configured to store information about a correspondence relationship between an internal user for a call center system and an external user for the call center system;

a correspondence relationship establishing unit, configured to establish the information about the correspondence relationship between the internal user for the call center system and the external user for the call center system, and to send the information about the correspondence relationship to the storing unit for storage; and

an internal user determining unit, configured to determine information about the internal user for the call center system corresponding to the external user for the call center system by inquiring the information about the correspondence relationship stored in the storing unit when the external user for the call center system initiates a call.

It can be seen from the solutions provided in the invention that the information servicing function provided in the existing communication networks may be utilized in the invention. After a call initiated from an internal user for a call center system to an external user fails, the call center system sends the call information to the external user in a timely manner, so that the external user can obtain identification information of the internal user for the call center system in a timely and accurate manner. Accordingly, the possibility of reaching the internal user for the call center system is enhanced and thus the interests of the external user and the enterprise entity can be secured.

### BRIEF DESCRIPTION OF THE DRAWINGS

FIG. 1 is a schematic diagram showing the implementation of a call center system in the prior art;

FIG. 2 illustrates the configuration of a call center system according to an embodiment of the invention;

FIG. 3 illustrates the configuration of an intelligent communication apparatus according to a first embodiment of the present invention; and

FIG. 4 illustrates the configuration of an intelligent communication apparatus according to a second embodiment of the present invention.

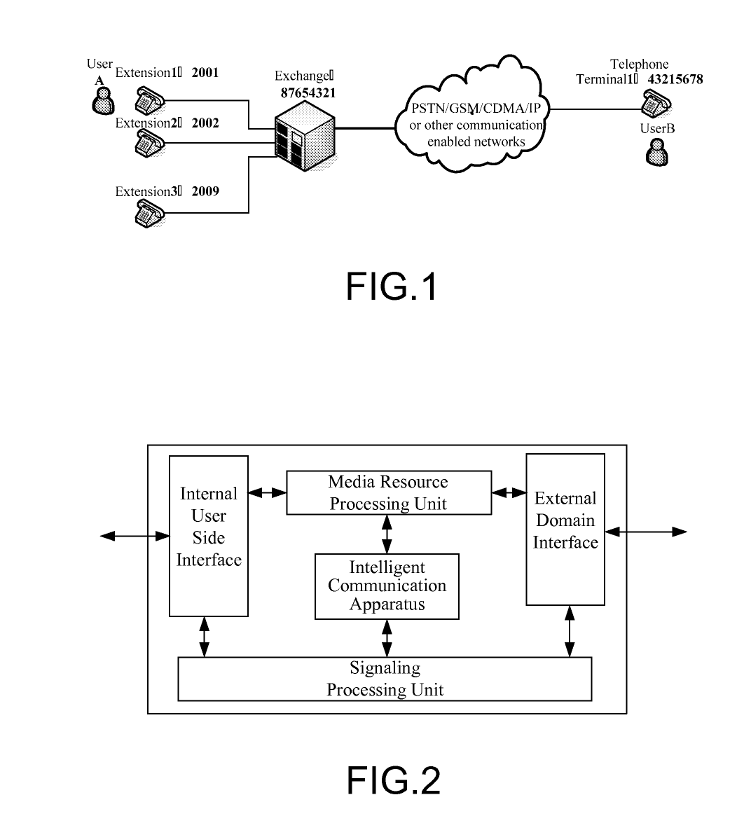

### DETAILED DESCRIPTION

To address the problem that the identification information of an internal user for a call center system cannot be determined when an external user for the call center system makes a callback, an embodiment of the present invention provides a feasible solution to solve the problem. The configuration of the call center system is shown in FIG. 2.

The present invention provides two embodiments of a method for determining an internal user for a call center system. Detailed descriptions will be given below to the two embodiments.

In a first embodiment of the present invention, after a call initiated from an internal user for a call center system to an external user via the call center system fails, the call center system determines call information, and sends the call information to the external user, the call information including identification information of the internal user initiating the call.

Specifically, after a call initiated from an internal user for the call center system to another user in a communication network domain external to the call center system fails, the call center system determines the call information. The call center system determines a communication network or operator to which the external user belongs, and transmits the call information to the external user in a short message via a corresponding gateway.

Specifically, the call center system according to the first embodiment may include a telephone exchange system or any other system having the function of a telephone exchange.

An internal user for the call center system according to the first embodiment may specifically include an internal user for the telephone exchange system or in any other system having the function of a telephone exchange. The identification information of the internal user may specifically include the telephone number of the internal user or any other information.

An external user according to the first embodiment may specifically include the user of any communication terminal having message reception and transmission function in an existing communication network and outside the call center system, such as a mobile phone. The identification information of the external user may specifically include the telephone number of the mobile phone or any other information.

Besides including identification information of the internal user which may determine the identity of the internal user for the call center system, the call information according to the first embodiment may include but is not limited to one or more of the following: identification information of the call center system, identification information of the external user for the call center system, call occurrence time and description of an enterprise entity to which the call center system belongs. Other information may be included as well, which may be set arbitrarily by the call center system as desired or may be changed at any time.

For a better understanding of the first embodiment, a detailed description will be made below to the specific implementation of the method for determining an internal user for the call center system according to the first embodiment with reference to the configuration of the call center system shown in FIG. 2. Specifically, the flow may include the following steps.

In step 1, an internal user for the call center system initiates a call and inputs the identification information, and completes the signaling interaction with the call center system.

The identification information inputted by the internal user may be the identification information of an internal user for the call center system or the identification information of an external user for the call center system.

In step 2, the call center system analyzes the identification information and determines the identity of the called user.

If the call center system determines that the called user is an internal user for the call center system, the call center system initiates a call to the called internal user via the intra LAN.

If the call center system determines that the called user is an external user for the call center system, the call center system initiates a call to the called external user via the outside communication network.

In step 3, the call center system detects the response information from the called internal or external user, and performs a subsequent operation based on the detection result.

When detecting the response information from the called internal or external user, the call center system stops sending ring back tone to the internal user for the call center system, and establishes a communication connection between the calling and called parties.

When detecting no response information from the called internal or external user, that is, the call fails, and the call center system determines the call information. When the call center system detects no response information from the called internal user, the identification information displayed on the communication terminal of the called internal user is the identification information of the calling internal user. Thus, the called internal user may determine the identification information of the calling internal user when a callback is to be made. Therefore, the call center system may take no action for a failing call inside the intra LAN. Alternatively, the call center system may record the call information for other use. The flow ends here.

When detecting no response information from the called external user, the call center system determines the call information.

The call information may include identification information of the internal user, and the identification information may be used for determining the identity of the internal user for the call center system. The call information may further include but may not be limited to one or more of the following: identification information of the call center system, identification information of the external user for the call center system, call occurrence time, and description of an enterprise entity to which the call center system belongs. Other information may be included as well, which may be set arbitrarily by the call center system as desired or may be changed at any time.

In step 4, the call center system determines a communication network or operator to which the external user belongs.

After the call fails and the internal user for the call center system hangs up, the call center system begins to perform an operation to determine a communication network or operator to which the external user belongs.

Because users in different communication networks or operators may have different user identification information, the call center system may analyze the identification information of an external user, and then may determine the communication network or operator to which the external user belongs.

In step 5, the call information is transmitted.

After determining the communication network or operator to which the external user belongs, the call center system may send the call information containing the identification information of the internal user for the call center system to the external user via a corresponding gateway.

The transmission may be conducted via a short message or the like, as determined by the call center system.

The short message service provided by the communication network or operator may be directed to text, audio, video or the like. Furthermore, no communication fee will be charged for receiving a short message. Therefore, the call center system transmits the call information including the identification information of the internal user for the call center system to the external user in a short message. Thus, the external user may have the identification information of the internal user for the call center system in a timely and accurate manner, and no communication fee of the external user will be wasted. The object of the present invention is fulfilled.

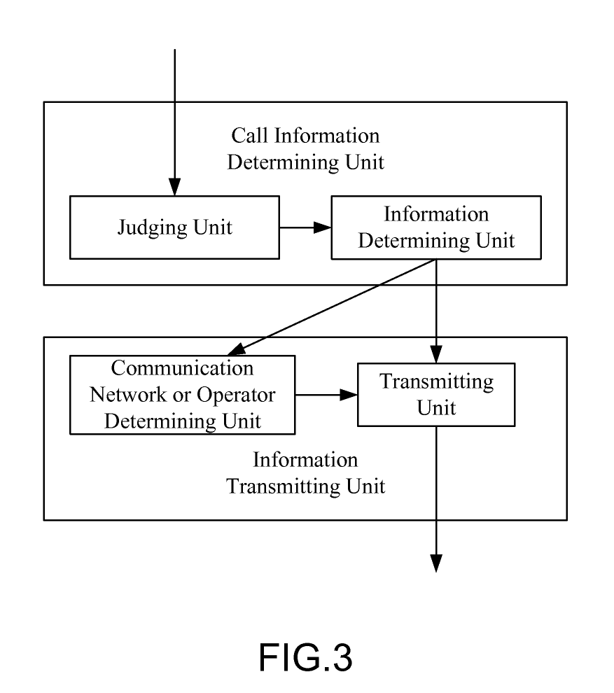

The first embodiment also provides an intelligent communication apparatus having short message transmission and reception function. The configuration of the apparatus is shown in FIG. 3. The apparatus may be located in a call center system, or may be located outside and coupled to the call center system, so as to control other apparatuses inside the call center system.

Specifically, the intelligent communication apparatus includes a call information determining unit and an information transmitting unit.

The call information determining unit is configured to determine the call information after a call initiated from an internal user for the call center system to a called external user via the call center system fails.

Specifically, the call information determining unit may include a judging unit and an information determining unit.

The judging unit is configured to judge whether the call initiated from the internal user for the call center system to the external user via the call center system fails, and to trigger a subsequent functional unit after judging that the call fails.

The information determining unit is configured to determine the call information, the call information including identification information of the internal user for the call center system initiating the call, as well as at least one of the following: identification information of the call center system, identification information of the external user for the call center system, call occurrence time and description of an enterprise entity to which the call center system belongs. Specifically, it may be set by the information determining unit arbitrarily.

The information transmitting unit is configured to transmit the call information to the external user.

Specifically, the information transmitting unit may include a communication network or operator determining unit and a transmitting unit.

The communication network or operator determining unit is configured to determine a communication network or operator to which the external user belongs.

The communication network or operator determining unit may determine the communication network or operator to which the external user belongs by using the identification information of the external user.

The transmitting unit is configured to transmit the information determined by the call information determining unit to the external user via a corresponding gateway based on the determination result of the communication network or operator determining unit.

The transmitting unit may transmit the call information determined by the call information determining unit to the external user via a short message or the like.

In the second embodiment of the present invention, the call center system establishes information about the correspondence relationship between the internal user and the external user. After determining that the external user initiates a call, the call center system may determine information about the internal user based on the correspondence relationship information.

After a call initiated from an internal user for the call center system to another user in a communication network domain external to the call center system fails and/or succeeds, the call center system stores information about the correspondence relationship between the internal user and the external user, for the purpose of future query. When the call center system determines that the external user initiates a call, the call center system may determine the internal user for the call center system associated with the external user based on the external user information by querying the related stored information in the call center system. A communication connection may be established. The call is completed.

According to the second embodiment, the call initiated by the external user may specifically include a call actively initiated by an external user, a callback initiated by an external user, or any other call initiated by the external user.

The call center system according to the second embodiment may specifically include a telephone exchange system or any other system having the function of a telephone exchange.

An internal user for the call center system according to embodiment 2 may specifically include an internal user for the telephone exchange system or for any other system having the function of a telephone exchange. The information about the internal user may specifically include the telephone number of the internal user or any other information.

An external user according to embodiment 2 may specifically include the user of any communication terminal such as a fixed telephone or a mobile phone in an existing communication network and outside the call center system. The information about the external user may specifically include the number of the fixed telephone or the mobile phone, or include any other information.

According to the second embodiment, the information about the correspondence relationship between the internal user and the external user established and stored in the call center system may specifically include information about the internal user for the call center system, information about the external user for the call center system, occurrence time for the call initiated from the internal user for the call center system to the external user, and stored information aging time allocated by the call center system. The content of the correspondence relationship information may be set by the call center system as desired and may be changed at any time. Also, the content of the information is not limited to the above described information.

The call center system according to the second embodiment may store many pieces of correspondence relationship information. Meanwhile, to prevent too much information being stored from occupying a large amount of resources at the call center system and affecting the normal operation of the call center system, the call center system sets a stored information aging time for each piece of stored information, and deletes the stored information to which the stored information aging time belongs after the stored information aging time expires. The aging time may be in units of second, minute, hour, day, month, year or the like, which may be set by the exchange system and changed as desired.

For a better understanding of embodiment 2, a detailed description will be made below to the specific implementation of the method for determining an internal user for the call center system according to the second embodiment with reference to the configuration of the call center system shown in FIG. 2. Specifically, the flow may include the following steps.

In step 1, an internal user for the call center system initiates a call and inputs the identification information, and completes the signaling interaction with the call center system.

The identification information inputted by the internal user may be information about the called internal user for the call center system or information about the external user for the call center system.

In step 2, the call center system analyzes the identification information and determines the identity of the called user.

If the call center system determines that the called user is an internal user for the call center system, the call center system initiates a call to the called internal user via the intra LAN.

If the call center system determines that the called user is an external user for the call center system, the call center system initiates a call to the called external user via the outside communication network.

In step 3, when detecting the response information from the called internal or external user, the call center system stops sending ring back tone to the internal user for the call center system, and establishes a communication between the calling and called parties.

When the call center system successfully establishes the communication connection between the internal user and the external user, the call center system stores information about the call, including information about the internal user and information about the external user, the call time, and the stored information aging time. The call center system may accumulate the call information stored in a time period, so that the call center system may manage and control the internal users. Alternatively, the call center system may store no information about the call procedure.

When the call center system successfully establishes the communication connection between the internal user and the external user, the call center system stores the information about the correspondence relationship between the internal user and the external user for the call center system. The correspondence relationship information may include information about the internal user for the call center system, information about the external user for the call center system, call occurrence time and the stored information aging time.

In step 4, when the call fails, the call center system stores the information.

When the call center system detects no response information from the called internal user, the identification information displayed on the communication terminal of the called internal user is the identification information of the calling internal user. Then, the called internal user can determine the identification information of the calling internal user when a callback is to be made. Therefore, even if the call center system stores no information about this call, the callback from the internal user will not be affected. Alternatively, the call center system may store the information about this call, and the call center system may accumulate the stored information for a time period so that the call center system may manage and control the internal users. The flow then comes to an end here.

When the call center system detects no response information from the called external user, the call center system will store the correspondence relationship information for this call, including information about the internal user for the call center system, information about the external user for the call center system, call time and the stored information aging time. At this point, information about the call center system may be displayed on the communication terminal of the external user.

In step 5, after determining that the external user initiates a call, the call center system may determine information about the internal user based on the correspondence relationship information.

When the external user initiates a call, the call center system determines that the external user initiates a call and queries the related stored information based on the information about the external user. At this point, there may be two cases: the call center system finds information related to the external user, or the call center system finds no information related to the external user. Detailed descriptions will be made below to the subsequent operations of the call center system in the two cases, respectively.

Case 1: The call center system finds information related to the external user

In this case, the call center system performs information interaction with the external user via Interactive Voice Response (IVR). A voice prompts the external user to choose a function service provided by the call center system.

The function service provided by the call center system may be but is not limited to one or more of the following operations.

1. The function service provided by the call center system may be “Please input information about the internal user”.

At this point, if the external user exactly knows the information about the internal user for the call center system, the information about the internal user for the call center system may be input. The call center system diverts the call to the designated internal user and a communication connection is established. If the external user has no knowledge about the internal user for the call center system, the external user may choose other services.

2. The function service provided by the call center system may be “Please press a certain key if information query is desired”.

At this point, the call center system diverts the call initiated by the external user to a particular person. The person will exchange information with the external user via voice manually, and the information displayed on the call center system may include but is not limited to one or more of the following.

(1) Information about the internal user calling the external user most recently

(2) Information about one or more internal users calling the external user in a recent time period

(3) Information about an internal user calling the external user most frequently in a recent time period

The time period may be set by the call center system, for example to a minute or an hour.

The selected information may be set and changed by the call center system as desired. The selected information may be more, and may be set by a user of the call center system freely.

3. The function service provided by the call center system may be “Please select information about an internal user related with you”.

If the external user selects this service, the call center system prompts the function service via voice. One or more of the following may be used, but the invention is not limited herein.

(1) The call center system will prompt “do you select the internal user initiating a most recent call”.

The call center system prompts information about the internal user calling the external user most recently to the external user via voice, and prompts that the external user may or may not choose acceptance, for example, “Press 1 for acceptance, and press 2 for rejection”. If the external user chooses acceptance, the call center system connects to the internal user and establishes a communication connection. If the external user chooses rejection, the call center system returns to the previous interface.

(2) The call center system will prompt “Do you select one or more internal users initiating calls in a recent time period”.

The call center system provides information about one or more internal users calling the external user in a recent time period via voice, and prompts that the external user may choose to accept or not to accept, for example, “Press 1 for acceptance, and press 2 for rejection”. If the external user chooses to accept, the call center system prompts the external user to input information about the internal user. The external user selects one from the information about the one or more internal users and inputs it into the call center system. The call center system connects to the internal user and establishes a communication connection. If the external user chooses not to accept, the call center system returns to the previous interface. The time period may be set by the call center system, for example, to a minute or an hour.

(3) The call center system will prompt “do you select the internal user initiating most calls in a recent time period”

The call center system provides information about the internal user initiating most calls to the external user in a recent time period via voice, and prompts that the external user may choose to accept or not accept, for example, “Press 1 for acceptance, and press 2 for rejection”. If the external user chooses to accept, the call center system connects to the internal user and establishes a communication connection. If the external user chooses not to accept, the call center system returns to the previous interface. The time period may be set by the call center system, for example, to a minute or an hour.

The above selected information may be set and changed arbitrarily by the call center system as desired. The selected information may be more, and may be set by a user of the call center system freely.

Case 2: The call center system finds no information related to the external user

In this case, the call center system performs information interaction with the external user via Interactive Voice Response (IVR). The external user is prompted via voice to choose a function service provided by the call center system.

The function service provided by the call center system may be but is not limited to one or more of the following.

1. The function service provided by the call center system may be “please input information about the internal user”.

At this point, if the external user exactly knows the information about the internal user for the call center system, the information about the internal user for the call center system may be inputted. The call center system connects with the designated internal user and a communication connection is established. If the external user does not know the information about the internal user for the call center system, the external user may choose other services.

2. The function service provided by the call center system may be “please press a certain key if information query is desired”.

At this point, the call center system diverts the call initiated by the external user to a particular person. The particular person will exchange information with the external user, to determine the internal user.

3. The function service provided by the call center system may be “please press a certain key if you make a callback with a new communication terminal”.

When the external user accepts the service, the call center system will prompt the external user via voice to input information about the original called external user.

If the call center system finds related information in the stored information after the external user inputs information about the original called external user, the call center system switches to the interface “The call center system finds information about the external user”. The external user continues to exchange information with the call center system, to determine information about the internal user for the call center system.

If the call center system finds no related information in the stored information after the external user inputs information about the original called external user, the query result is prompted to the external user via voice. Then, the external user is prompted to return to the previous interface, or an automatic return is performed to the previous interface.

The above selected information may be set and changed arbitrarily by the call center system as desired. The selected information may be more, and may be set by a user of the call center system freely.

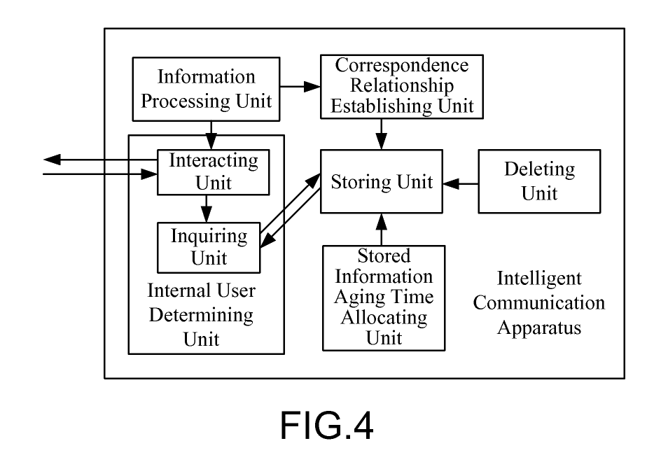

The second embodiment also provides an intelligent communication apparatus, the configuration of which is shown in FIG. 4. The apparatus may be located in a call center system, or may be located outside and coupled to the call center system, so as to control other apparatuses in the call center system. The following units are included.

(1) An information processing unit is configured to analyze call information received by a call center system, determine the initiator of the call information, and to send the call information to the correspondence relationship establishing unit or the internal user determining unit, the call information including information about the internal user for the call center system and/or information about the external user.

(2) A stored information aging time allocating unit is configured to allocate an aging time to each piece of stored information in a storing unit.

(3) The storing unit is configured to store information about a correspondence relationship between an internal user for a call center system and an external user for the call center system. The correspondence relationship information may include information about the internal user for the call center system, information about the external user for the call center system, call occurrence time, and stored information aging time. The correspondence relationship information may be set by the call center system and changed as desired. The content of the information is not limited to the above described information.

(4) A correspondence relationship establishing unit is configured to establish, based on the information about the internal user for the call center system and the information about the external user included in the information sent from the information analyzing unit, the information about the correspondence relationship between the internal user and the external user, and send the information about the correspondence relationship and the information from the information analyzing unit to the storing unit in the apparatus for storage as the stored information.

(5) An internal user determining unit is configured to determine, by inquiring the information about the correspondence relationship between the internal user for the call center system and the external user stored in the storing unit, an internal user when the external user initiates a call. The internal user determining unit may include an interacting unit and an inquiring unit. The interacting unit is configured to perform information interaction with the external user, and transmit to the inquiring unit information obtained via the interaction and the information sent from the information processing unit. The inquiring unit is configured to inquire the storing unit for the information about the correspondence relationship between the internal user for the call center system and the external user based on the received information, and send the inquiry result to the call center system so that a call connection is established by the call center system.

(6) A deleting unit is configured to delete the stored information to which the stored information aging time belongs after determining that the stored information aging time expires.

The invention has been described above with reference to preferred embodiments, which are not used to limit the scope of the invention. Within the scope of the invention, those skilled in the art may make various changes and substitutions without departing from the spirit and principle of the invention.

What is claimed is:

1. A method for determining an internal user for a call center system, comprising:
determining call information, by the call center system, after a call initiated from the internal user for the call center system to an external user for the call center system via the call center system fails, the call information comprising identification information of the internal user for the call center system initiating the call; and
transmitting, by the call center system, the call information to the external user for the call center system.

2. The method according to claim 1, wherein the call information determined further comprises at least one of the following: identification information of the call center system, identification information of the external user for the call center system, call occurrence time, and description of an enterprise entity to which the call center system belongs.

3. The method according to claim 1, wherein the transmitting, by the call center system, the call information to the external user for the call center system, further comprises:
identifying, by the call center system, a communication network or operator to which the external user for the call center system belongs, and transmitting the call information to the external user for the call center system via a corresponding gateway.

4. The method according to claim 1, wherein the call center system transmits the call information to the external user for the call center system by transmitting a short message to the external user for the call center system.

5. The method according to claim 4, further comprising:
receiving the short message, by the external user for the call center system, and obtaining information about the internal user for the call center system initiating the call.

6. An intelligent communication apparatus, comprising:
a call information determining unit, configured to determine call information after a call initiated from an internal user for a call center system to an external user for the call center system via the call center system fails, the call information comprising identification information of the internal user for the call center system initiating the call; and
an information transmitting unit, configured to transmit the call information to the external user.

7. The intelligent communication apparatus according to claim 6, wherein the call information determining unit comprises:
a judging unit, configured to judge whether the call initiated from the internal user for the call center system to the external user for the call center system via the call center system fails, and to trigger a subsequent functional unit after judging that the call fails; and
an information determining unit, configured to determine the call information, the call information comprising identification information of the internal user for the call center system initiating the call.

8. The intelligent communication apparatus according to claim 6, wherein the information transmitting unit comprises:
a communication network or operator determining unit, configured to determine a communication network or operator to which the external user for the call center system belongs, and
a transmitting unit, configured to transmit the call information to the external user for the call center system via a corresponding gateway based on the determination result of the communication network or operator determining unit.

9. The intelligent communication apparatus according to claim 6, wherein the intelligent communication apparatus is located in a call center system.

10. A method for determining an internal user for a call center system, comprising:
establishing, by the call center system, information about a correspondence relationship between the internal user for the call center system and an external user for the call center system, after a call initiated from the internal user for the call center system to the external user for the call center system via the call center system fails; and
determining, by the call center system, information about the internal user for the call center system corresponding to the external user for the call center system based on the information about the correspondence relationship after the external user for the call center system initiates a call.

11. The method according to claim 10, wherein the information about the correspondence relationship comprises: information about the internal user for the call center system, information about the external user for the call center system, call occurrence time, and stored information aging time allocated by the call center system.

12. The method according to claim 11, wherein after the stored information aging time expires, the call center system deletes the information about the correspondence relationship to which the stored information aging time belongs.

13. The method according to claim 10, further comprising:
establishing, by the call center system, the information about the correspondence relationship between the internal user for the call center system and the external user for the call center system after the call initiated from the internal user for the call center system to the external user for the call center system via the call center system succeeds.

14. The method according to claim 10, further comprising:
determining by the call center system, information about the internal user for the call center system by performing information interaction with the external user for the call center system via voice interaction, and
sending the determined information about the internal user for the call center system to the external user for the call center system.

15. The method according to claim 14, further comprising:
prompting, by the call center system, the external user for the call center system to input information about original communication terminal corresponding to the internal user for the call center system when the external user for the call center system initiates a call to the internal user for the call center system via a replaced communication terminal.

16. An intelligent communication apparatus, comprising:
a correspondence relationship establishing unit, configured to establish information about the correspondence relationship between the internal user for the call center system and the external user for the call center system, and send the information about the correspondence relationship to the storing unit;
a storing unit, configured to store information about a correspondence relationship between an internal user for a call center system and an external user for the call center system; and
an internal user determining unit, configured to determine information about the internal user for the call center system corresponding to the external user for the call center system by inquiring the information about the correspondence relationship stored in the storing unit when the external user for the call center system initiates a call.

17. The intelligent communication apparatus according to claim 16, further comprising:
an information processing unit, configured to analyze call information received by a call center system, to determine initiator information in the call information, and to send the initiator information to the correspondence relationship establishing unit or the internal user determining unit, the initiator information comprising at least one of information about the internal user for the call center system and information about the external user for the call center system.

18. The intelligent communication apparatus according to claim 16, further comprising:
a stored information aging time allocating unit, configured to allocate a stored information aging time to the information about the correspondence relationship stored in the storing unit; and
a deleting unit, configured to delete the information about the correspondence relationship to which the stored information aging time belongs after the stored information aging time expires.

19. The intelligent communication apparatus according to claim 17, wherein the internal user determining unit comprises an interacting unit and an inquiring unit, wherein:
the interacting unit is configured to perform information interaction with the external user for the call center system, and to transmit information obtained via the interaction to the inquiring unit along with the information sent from the information processing unit; and
the inquiring unit is configured to inquire the storing unit for the information about the correspondence relationship between the internal user for the call center system and the external user for the call center system based on the received information, and to send the inquiry result to the call center system.
